(19) United States
(12) Patent Application Publication
(10) Pub. No.: US 2021/0259385 A1
(43) Pub. Date: Aug. 26, 2021

(54) NAIL ART AND METHOD FOR PREPARING THE NAIL ART

(71) Applicant: GlluGa Inc., Cheonan-si (KR)

(72) Inventor: Jun Gil UM, Hwaseong-si (KR)

(21) Appl. No.: 17/135,013

(22) Filed: Mar. 12, 2021

(30) Foreign Application Priority Data
Dec. 27, 2019 (KR) 10-2019-0176042
Dec. 28, 2020 (KR) 10-2020-0184806

(51) Int. Cl. A45D 29/00; C08L 1/18; C08L 33/08; C08L 75/04

(52) U.S. Cl. CPC A45D 29/001; C08L 1/18; A45D 2029/005; C08L 75/04; C08L 33/08

(57) ABSTRACT

Provided are a nail art including: a substrate layer and a coating layer positioned on the substrate layer, wherein the coating layer includes a UV-curable raw material, a photoinitiator, and a resin, and the following Equation 1 is satisfied, and a method for preparing the same:

0.05 mm<T₂−T₁<0.6 mm [Equation 1]
wherein T₁ is a thickness of the nail art measured in an outer periphery of the nail art, and T₂ is a thickness of the nail art at a point of 1 mm away from the outer periphery of the nail art toward a center of the nail art.

### CROSS-REFERENCE TO RELATED APPLICATION

This application claims the benefit of priority to Korean Patent Application Nos. 10-2019-0176042 and 10-2020-0184806, filed in the Korean Intellectual Property Office on Dec. 27, 2019 and Dec. 28, 2020, respectively, the entire contents of which are incorporated herein by reference.

### TECHNICAL FIELD

The present disclosure relates to a nail art and a method for preparing the nail art, the nail art being characterized by having a novel shape.

### BACKGROUND

The beauty industry has been acceleratedly developed and subdivided simultaneously, as one way of expression of physical beauty pursued by humans. In particular, the beauty industry began to be popularized among ordinary people together with rapid market expansion after the 20th century. In the beauty industry, nail art has been recently rapidly developed as an essential element of expression arts for the body regardless age group and gender.

Originally, nail art is one of the ways for beautifully decorating the human body as a field of beauty arts, and the length, shape, or color of a nail has been expressed by reflecting changes and values of the culture of the times.

Among the nail arts, a nail art in an artificially manufactured nail or toenail shape (often called a nail sticker) is used by many people. In the past, the nail art was manufactured in a curved shape like a nail or toenail shape and supplied to consumers. However, since each person has different nail or toenail shape (in particular a curvature radius), it was difficult to closely adhere a nail art having an already curved shape to a nail or toenail of a consumer.

As a method of solving the problem, a nail art including a UV-curable raw material has been recently spotlighted. Specifically, consumers deforms the nail art to fit their nail or toenail and irradiate UV thereon to cure the nail art. Accordingly, the nail art is closely adhered to the consumers' nail or toenail, thereby improving adhesive strength of the nail art.

Meanwhile, a conventional nail art is formed to be close to vertical to an upper surface of the nail art. Referring to FIG. 2, the side surface 100b and the upper surface 100a of the nail art 100 are almost vertical to each other. Accordingly, an outer peripheral portion of the conventional nail art is easily worn during consumer's lives and the nail art is easily released from a nail or toenail by external shock. Such problems occur more seriously due to the small thickness of the nail art. In addition, since the side surface 100b and the upper surface 100a of the nail art are almost vertical to each other, a direction in which light is reflected is excessively limited, and thus, the nail art does not look three-dimensional to lose the purpose of beauty.

### RELATED ART DOCUMENTS

[Patent Documents]

(Patent Document 1) Korean Patent Laid-Open Publication No. 10-2019-0014044

### SUMMARY

The present disclosure has been made to solve the above-mentioned problems occurring in the prior art while advantages achieved by the prior art are maintained intact.

An aspect of the present disclosure provides a nail art having reduced wear and high attachment ability, and looking three-dimensional to maximize beauty characteristic.

Another aspect of the present disclosure provides a method for preparing the nail art.

According to an aspect of the present disclosure, a nail art includes: a substrate layer and a coating layer positioned on the substrate layer, wherein the coating layer includes a UV-curable raw material, a photoinitiator, and a resin, and the following Equation 1 is satisfied:

0.05 mm≤T₂−T₁≤0.6 mm [Equation 1]

wherein T₁ is a thickness of the nail art measured in an outer periphery of the nail art, and T₂ is a thickness of the nail art at a point of 1 mm away from the outer periphery of the nail art toward a center of the nail art.

According to another aspect of the present disclosure, a method for preparing a nail art includes: forming a coating layer from a coating layer forming composition by a screen printing method (S1), wherein the nail art includes a substrate layer and the coating layer positioned on the substrate layer, the coating layer includes a UV-curable raw material, a photoinitiator, and a resin, and the following Equation 1 is satisfied:

0.05 mm≤T₂−T₁≤0.6 mm [Equation 1]

wherein T₁ is a thickness of the nail art measured in an outer periphery of the nail art, and T₂ is a thickness of the nail art at a point of 1 mm away from the outer periphery of the nail art toward a center of the nail art.

### BRIEF DESCRIPTION OF THE DRAWINGS

The above and other objects, features and advantages of the present disclosure will be more apparent from the following detailed description taken in conjunction with the accompanying drawings:

FIG. 1 is a schematic plan view for describing a nail art;

FIG. 2 is a schematic cross-sectional view of a conventional nail art confirmed along line A-A′ of FIG. 1;

FIG. 3 relates to the nail art according to an exemplary embodiment of the present disclosure, and is a schematic cross-sectional view of the nail art of the present disclosure, confirmed along line A-A′ of FIG. 1;

FIGS. 4 to 6 are a drawing for describing the nail art according to an exemplary embodiment of the present disclosure and an enlarged schematic cross-sectional view of part B of FIG. 3;

FIG. 7 is a schematic view for describing the method for preparing a nail art according to another exemplary embodiment of the present disclosure;

FIGS. 8 and 9 are photographs before/after wear evaluation of the nail art of Example 1, respectively;

FIGS. 10 and 11 are photographs before/after wear evaluation of the nail art of Comparative Example 1, respectively; and

FIGS. 12 and 13 are photographs before/after wear evaluation of the nail art of Comparative Example 2, respectively.

### DETAILED DESCRIPTION

Since the present disclosure may be variously modified and have several exemplary embodiments, specific exemplary embodiments will be shown in the accompanying drawings and be described in detail in a detailed description.

However, it is to be understood that the present disclosure is not limited to a specific exemplary embodiment, but includes all modifications, equivalents, and substitutions without departing from the scope and spirit of the present disclosure. When it is determined that the detailed description of the known art related to the present disclosure may obscure the gist of the present disclosure, the detailed description thereof will be omitted.

Terms used in the present specification are used only in order to describe specific exemplary embodiments rather than limiting the present disclosure. Singular forms are intended to include plural forms unless otherwise indicated contextually.

It will be further understood that in the present disclosure, the term such as “comprises” or “have” specifies the presence of stated features, numerals, steps, operations, constituent elements, parts, or a combination thereof, but does not preclude the presence or addition of one or more other features, numerals, steps, operations, constituent elements, parts, or a combination thereof.

In the present disclosure, being disposed or positioned “on” a subject may mean not only being present on the subject in a directly abutting state but also being disposed or positioned on the subject in a spaced state.

A thickness measured in the present disclosure may be confirmed by equipment of VHX-970F available from Keyence.

In the present disclosure, a viscosity may be measured by a viscometer available from Brookfield.

<Nail Art>

A nail art means an artificial laminate structure manufactured for being attached to a nail or toenail. Considering the use to be attached, it is also called a nail sticker or a nail art sticker. Specifically, when consumers are supplied with the nail art, the consumers attach the nail art on their nail or toenail while deforming the nail art to closely adhere the nail art on a nail or toenail, and then may irradiate UV to cure the nail art.

The nail art according to an exemplary embodiment of the present disclosure includes: a substrate layer and a coating layer positioned on the substrate layer, wherein the coating layer may include a UV-curable raw material, a photoinitiator, and a resin, and the following Equation 1 may be satisfied:

0.05 mm≤T₂−T₁≤0.6 mm [Equation 1]

wherein T₁ is a thickness of the nail art measured in an outer periphery of the nail art, and T₂ is a thickness of the nail art at a point of 1 mm away from the outer periphery of the nail art toward a center of the nail art.

The coating layer may include a UV-curable raw material, a photoinitiator, and a resin.

Since the UV-curable raw material is included in the coating layer, consumers who purchased the nail art may deform the nail art so to be closely adhered to their nail or toenail, and then irradiate UV to cure the nail art to fix the deformed nail art. Accordingly, the nail art and the nail/toenail may be joined to each other in a completely closely adhered state, thereby improving adhesive strength of the nail art. In addition, even in the case in which the coating layer forming composition is dried to remove the solvent, the coating layer has a predetermined viscosity, and thus, the nail art may satisfy Equation 1.

The UV-curable raw material may include at least any one selected from the group consisting of urethane acrylate-based oligomers, polyester acrylate-based oligomers, polyether acrylate-based oligomers, epoxy acrylate-based oligomers, polycarbonate acrylate-based oligomers, silicone acrylate-based oligomers, and acryl acrylate-based oligomers.

Specifically, the UV-curable raw material may include at least any one selected from the group consisting of urethane acrylate-based oligomers, polyester acrylate-based oligomers, and epoxy acrylate-based oligomers.

The urethane acrylate-based oligomer may be easily cured by UV and may have predetermined flexible physical properties even after curing, which is thus advantageous. In addition, a haze phenomenon may be minimized to maintain transparency of the coating layer.

The urethane acrylate-based oligomer may include at least any one selected from difunctional urethane acrylate-based oligomers, tetrafunctional urethane acrylate-based oligomers, hexafunctional urethane acrylate-based oligomers, and nonafunctional urethane acrylate-based oligomers.

Specifically, the urethane acrylate-based oligomer may include at least any one selected from the group consisting of PU210, PU280, PU640, and SC2404 available from Miwon Specialty and the Co., Ltd., and CN 9033 and CN 9047 available from SARTC MER.

The urethane acrylate-based oligomer may have a weight average molecular weight inner periphery of 1,000 g/mol to 1,000,000 g/mol, specifically 1,000 g/mol to 100,000 g/mol. When the range is satisfied, workability may be greatly improved.

Since the epoxy acrylate-based oligomer has high reactivity, it has high hardness and good abrasiveness, is easily cured, has excellent flexibility, and may be stably cured even in contact with oxygen.

The epoxy acrylate-based oligomer may have one functional group or two functional groups, and when it has one functional group, it shows ductility, and when it has more functional groups, it is advantageous for rigidity or thermal stability.

Specifically, the epoxy acrylate-based oligomer may include at least any one selected from the group consisting of PE210, PE 2120, and PE 250 available from Miwon Specialty Chemical Co., Ltd.

The epoxy acrylate-based oligomer may have a weight average molecular weight of 100 g/mol to 10,000 g/mol, specifically 500 g/mol to 6,000 g/mol. Considering the solid content and the viscosity of the coating layer forming composition, the above range is preferred.

The polyester acrylate-based oligomer has excellent reactivity and better adhesive strength than the urethane acrylate-based oligomer and the epoxy acrylate-based oligomer.

The polyester acrylate-based oligomer may be an oligomer having four or six functional groups.

Specifically, the polyester acrylate-based oligomer may include at least any one selected from the group consisting of PS4040, PS460, PS6300 Etermer 6311-100, 6312-100, and 6314C-60 available from Miwon Specialty Chemical Co., Ltd.

The polyester acrylate-based oligomer may have a weight average molecular weight of 500 g/mol to 50,000 g/mol, specifically 1,500 g/mol to 38,000 g/mol. When the range is satisfied, processability and adhesive strength may be improved.

Within the coating layer, the epoxy acrylate-based oligomer may be included at 1 parts by weight to 10 parts by weight, specifically 1 part by weight to 3 parts by weight with respect to 100 parts by weight of the urethane acrylate-based oligomer. Within the coating layer, the polyester acrylate-based oligomer may be included at 10 parts by weight to 20 parts by weight, specifically 2 parts by weight to 8 parts by weight with respect to 100 parts by weight of the urethane acrylate-based oligomer. When the composition is satisfied, rapid curing does not occur even in the case in which the coating layer is exposed to the air, and durability may be maintained even after the nail art is attached. In addition, regarding the manufacturing method of the present disclosure, having the composition affects flowability, and thus, a product having a natural line may be manufactured.

Unlike this, the UV-curable raw material may include the urethane acrylate-based oligomer, and specifically may be formed of the urethane acrylate-based oligomer.

The UV-curable raw material may be included at 10 wt % to 60 wt %, specifically 29 wt % to 49 wt % in the coating layer. When the range is satisfied, the product maintains flexible physical properties before UV irradiation, and then has very hard physical properties after curing by UV irradiation.

The photoinitiator serves to initiate a polymerization reaction by UV irradiation. Specifically, the photoinitiator may be a UV photoinitiator.

The photoinitiator may have an absorption wavelength band in a range of 200 nm to 600 nm.

The photoinitiator may include at least any one selected from the group consisting of trimethylbenzoyl phosphine oxide, phenylbis(2,4,6-trimethylbenzoyl)phosphine oxide, and 2-benzyl-2-(dimethylamino)-1-[4-(4-morpholinyl)phenyl]-1-butanone, but is not necessarily limited thereto.

The photoinitiator may be included at 1 wt % to 10 wt %, specifically 1 wt % to 5 wt % in the coating layer. When the range is satisfied, the nail art may have an appropriate hardness when a user cures the nail art.

The resin may serve to maintain the form by controlling the flowability of the coating layer. In addition, since a coating layer forming composition for forming the coating layer may have an appropriate viscosity by the resin, the coating layer may be prepared in a desired form.

The resin may be a thermoplastic resin having a glass transition temperature (T_{g}) of 30° C. to 200° C., specifically 50° C. to 120° C. When the range is satisfied, mobility of the resin is not high at room temperature, but due to drying in the manufacturing process of the nail art, the resin may be appropriately mixed with the UV-curable raw material therein to form a smooth side line of the nail art.

The resin may include at least any one selected from the group consisting of acryl-based resins, nitrocellulose resins, epoxy-based resins, polyester resin, polyvinyl resins, urethane resin, and vinyl acetate resins.

In particular, the resin may include an acryl-based resin and a nitrocellulose resin. The resin may have a glass transition temperature (T_{g}) of 30° C. to 200° C., specifically 50° C. to 120° C. The nitrocellulose resin may include HRS 1/8-20 SS type 1/8-1/2 from Korea CNC Ltd. A nitrogen content of the nitrocellulose resin may be 11.5% to 12.2%, and specifically, may be divided into ⅛ seconds-20 seconds depending on a viscosity. When the range is satisfied, a low viscosity may be maintained to increase the solid content.

The resin may be included at 30 wt % to 80 wt %, specifically 50 wt % to 70 wt % in the coating layer. When the range is satisfied, stickiness disappears so that there is no problem even in handling at room temperature and a round shape may be formed.

Meanwhile, the resin may also include a thermoplastic resin and a thermal initiator.

A weight ratio of the UV-curable raw material and the resin may be 10:90 to 50:50, specifically 30:70 to 40:60. When the range is satisfied, the nail art satisfies Equation 1, and the outer periphery of the nail art may have a gentle curve.

In some cases, the coating layer may include a solvent. The solvent corresponds to a solvent used when the coating layer forming composition for preparing the coating layer is formed, and is removed by drying in a process of preparing the coating layer. However, some solvents may remain at a very low content in the coating layer.

Referring FIGS. 3 to 5, an upper surface of the substrate layer 120 and a lower surface of the coating layer 110 may face each other, or specifically be in contact with each other. That is, the coating layer 110 may be positioned on the substrate layer 120.

An angle between the side surface and the lower surface of the substrate layer may be a right angle or similar to a right angle, and specifically, the angle may be 85° to 110°.

Referring to FIG. 6, the substrate layer 120 may also include an adhesive layer 121. The adhesive layer 121 imparts chemical adhesive strength to allow the nail art to be attached to a nail or toenail. Accordingly, the adhesive layer 121 may form a lowest surface of the nail art. The lower surface of the nail art of the present disclosure may be flat, which may mean that a lower surface of the adhesive layer 121 is flat. The adhesive layer 121 includes an adhesive component, which may correspond to an adhesive component commonly used in the art.

Referring to FIG. 6, the substrate layer 120 may further include a design layer 122. The design layer 122 may be positioned between the adhesive layer 121 and the coating layer 110. The design layer may include at least any one of a color layer and a printed layer. The design layer may include a pigment imparting color to the nail art. The printed layer may include various materials for aesthetics of particles, mica, and the like for pattern expression.

The nail art may further include a design expression layer disposed on the coating layer. The design expression layer may show expressions such as matte, and may show expressions such as three-dimensional lines, a thick film type three-dimensional figure like a cone or a circular dome, or the like.

A substrate film may be disposed on the lower surface of the substrate layer. The substrate film may serve to prevent contamination of the adhesive layer to maintain adhesive strength until the nail art is used, and corresponds to a configuration to be removed when the nail art is used. The substrate film may include a component commonly used in the art.

Referring to FIGS. 1, 3, and 4, the nail art may satisfy the following Equation 1:

0.05 mm≤T₂−T₁≤0.6 mm [Equation 1]

wherein T₁ is a thickness of the nail art measured in an outer periphery of the nail art, and T₂ is a thickness of the nail art at a point of 1 mm away from the outer periphery of the nail art toward a center of the nail art.

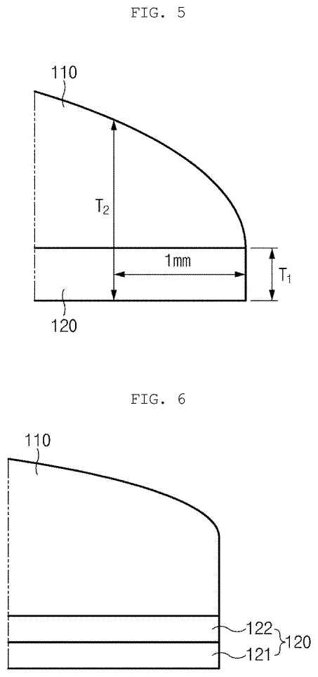

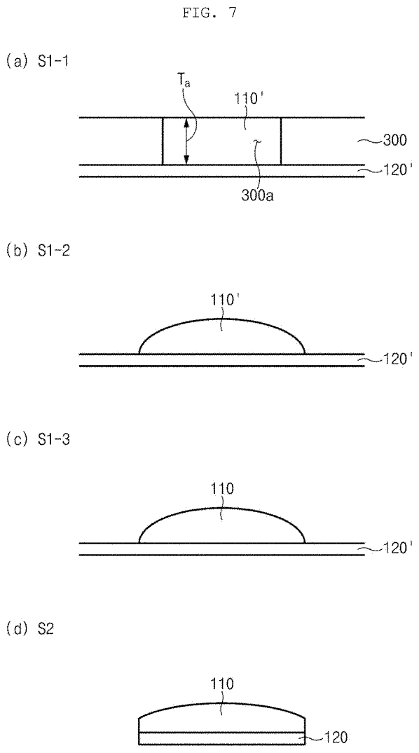

In the nail art, as shown in FIG. 4, a side surface of the coating layer is formed vertically or at an angle close to the vertical at the end of the substrate layer, and an upper portion of the coating layer may tilt to the center of the nail art while forming a curve. In addition, the nail art may have a thickness close to 0.1 mm at the end of the substrate layer as shown in FIG. 5, and in this case, and in this case, the coating layer corresponds to the case of not having a vertical side surface.

For detailed description, FIGS. 1, 3, 4, and 5 are referred. An outer periphery (S) of the nail art means a side surface of the nail art, and specifically, may mean a most protruding point of the side surface of the nail art.

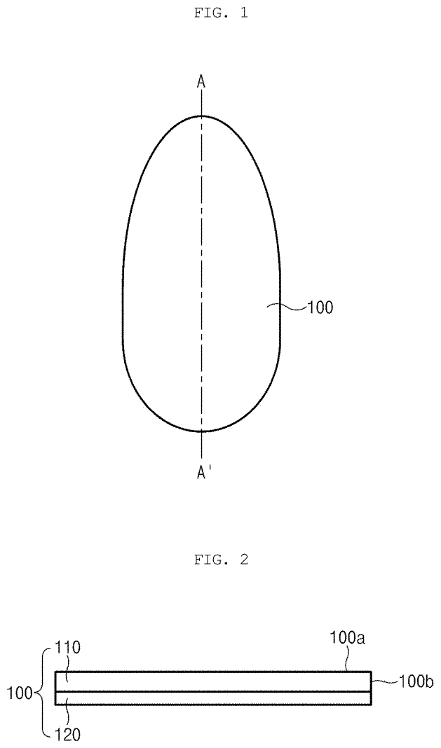

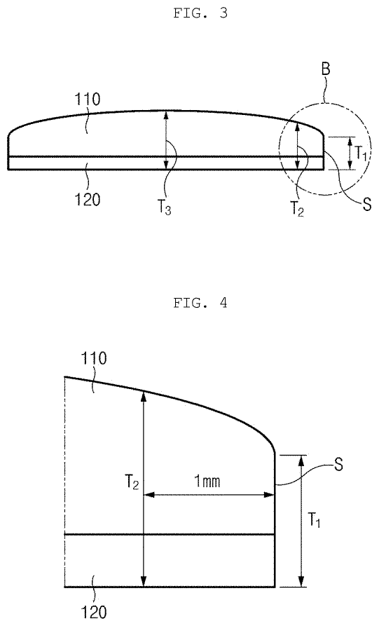

Equation 1 being satisfied means that the thickness of the nail art has an increased portion from the outer periphery of the nail art to a point of 1 mm away from the outer periphery of the nail art toward the center of the nail art. That is to say, unlike a conventional nail art in which the side surface and the upper surface of the nail art are almost vertical to each other (see FIG. 2), there is a portion where the thickness is increased from T₁ toward T₂, which means that a boundary between the upper surface and the side surface of the nail art is present as not a line but a gradual surface. Accordingly, it may be suppressed that the nail art has an excessive angular shape at a vicinity of the border. Accordingly, wear of the nail art (specifically wear of the coating layer) is suppressed, attachment ability is high, and the nail art may look three-dimensional to maximize beauty characteristics.

When Equation 1 is not satisfied and T₂−T₁<0.05 mm, the vicinity of the border of the nail art may have an excessively angular shape, and thus, wear of the nail art easily occurs and a cosmetic effect may be reduced. On the contrary, when T₂−T₁>0.6 mm, the nail art becomes excessively thick or the side surface of the nail art has a steep slope, so that a user may feel foreign body sensation more. Accordingly, when Equation 1 is satisfied, wear resistance of the nail art is improved, the cosmetic effect may be maximized, and a user may feel the foreign body sensation less.

More specifically, the nail art may satisfy the following Equation 1-1:

0.1 mm≤T₂−T₁≤0.4 mm. [Equation 1-1]

When Equation 1-1 is satisfied, wear resistance may be improved while a three-dimensional shape of the nail art is maintained, a defective rate may be decreased, and the shape is most similar to a nail art shape formed by using a conventional liquid nail art, and thus, it is convenient to use.

Specifically, T₂ may be 0.25 mm to 0.62 mm, more specifically 0.3 mm to 0.5 mm, and for example, 0.3 mm to 0.45 mm. In addition, T₁ may be 0.015 mm to 0.35 mm, specifically 0.02 mm to 0.25 mm. When the range is satisfied, a slope of a portion from T₁ to T₂ may have an appropriate level, and thus, rough expression by an angular phenomenon disappears and wear is also improved by a soft effect.

A point at which the thickness (T₃) of the thickest portion of the nail art is measured may be positioned closer to the center than a point of 1 mm away from the outer periphery of the nail art toward the center, and if necessary, may correspond to the center.

The thickness (T₃) of the thickest portion of the nail art may be 0.5 mm to 0.8 mm, specifically 0.52 mm to 0.7 mm. When the range is satisfied, the upper surface of the coating layer may have a convex portion, and thus, the durability of the upper end of the nail art may be improved, and a direction in which light is reflected from the nail art may be more varied, and thus, the cosmetic effect may be maximized.

Specifically, the nail art may satisfy the following Equation 2:

0.05 mm≤T₃−T₂≤0.6 mm. [Equation 2]

When the range is satisfied, a cosmetic effect may be maximized by the nail art having a convex shaped center, and durability of the vicinity of the center of the nail art may be increased.

More specifically, the nail art may satisfy the following Equation 2-2:

0.1 mm≤T₃−T₂≤0.4 mm. [Equation 2-2]

When Equation 2-2 is satisfied, a user may feel foreign body sensation less together with the effects described above, and UV curing may be evenly performed.

The lower surface of the coating layer may be flat. In addition, the lower surface of the nail art may be flat. The word “flat” means that there is no bend or step, or even in the case in which there is, in a very low level to be neglected. For example, an error range may be ±0.01 mm or less.

<Method for Preparing Nail Art>

The method for preparing a nail art according to another exemplary embodiment of the present disclosure may include: forming a coating layer from a coating layer forming composition by a screen printing method (S1), wherein the nail art includes a substrate layer and the coating layer positioned on the substrate layer, the coating layer includes a UV-curable raw material, a photoinitiator, and a resin, and the following Equation 1 is satisfied:

0.05 mm≤T₂−T₁≤0.6 mm [Equation 1]

wherein T₁ is a thickness of the nail art measured in an outer periphery of the nail art, and T₂ is a thickness of the nail art at a point of 1 mm away from the outer periphery of the nail art toward a center of the nail art. The thickness of the nail art may be increased from the outer periphery of the nail art to a point of 1 mm away from the outer periphery of the nail art toward the center of the nail art.

Since the UV-curable raw material, the photoinitiator, the resin, and Equation 1 are the same as those of the exemplary embodiment described above, descriptions thereof will be omitted.

The above S1 may include positioning a mask including a hole on a pre-substrate layer and then disposing the coating layer forming composition on the pre-substrate layer exposed by the hole (S1-1); removing the mask (S1-2); and drying the coating layer forming composition to form a coating layer (S1-3).

Referring to (a) of FIG. 7, in S1-1, a hole 300a included in the mask 300 is formed to penetrate the mask 300, and a circumference of the hole 300a have a shape of the coating layer 110 of the nail art.

In S1-1, the coating layer forming composition 110′ may be disposed to have a thickness (Tₐ) of 70 μm to 700 μm, specifically 70 μm to 500 μm, and more specifically 150 μm to 500 μm. When the coating layer forming composition 110′ satisfies the thickness, a side surface of the coating layer forming composition 110′ is deformed by gravity and a viscous property of the coating layer forming composition 110′ when the mask 300 is removed thereafter, and finally, the coating layer 110 may have the form described in the exemplary embodiment described above (see (d) of FIG. 7). When the thickness is less than 70 μm, the side surface and the upper surface of the coating layer forming composition 110′ are close to vertical to each other, and thus, it is difficult to show the form of the coating layer 110 of the present disclosure. On the contrary, when the thickness is more than 700 μm, it is difficult to dry the nail art, and it is difficult to form the shape of the nail art having an appropriate size when removing the mask.

In S1-1, a squeeze process including disposing the coating layer forming composition 110′ inside the hole 300a, and applying a pressure by a squeeze member, may be included. Thus, the coating layer forming composition 110′ may be easily disposed inside the hole 300a of the mask 300. The squeeze process may be performed several times, and for example, may be performed once to five times. That is to say, the coating layer forming composition 110′ may be disposed in the mask several times. Accordingly, the thickness of the coating layer forming composition 110′ disposed in the hole may be relatively constant and large.

The coating layer forming composition may include a UV-curable raw material, a photoinitiator, a resin, and a solvent. Since the UV-curable raw material, the photoinitiator, and the resin are the same as those of the exemplary embodiment described above, descriptions thereof will be omitted. The solvent may include at least any one selected from the group consisting of dibasic ester, ethylene glycol diacetate, and butylene glycol diacetate.

In a solid content of the coating layer forming composition, the UV-curable raw material may be included at 29 wt % to 49 wt %, the photoinitiator may be included at 1 wt % to 5 wt %, and the resin may be included at 50 wt % to 70 wt %. When the ranges are satisfied, the coating layer forming composition may have a preferred viscous property, and thus, the finally manufactured coating layer may have the form described in the exemplary embodiment described above.

The coating layer forming composition may have a viscosity of 4,500 cps to 10,000 cps, specifically 4,500 cps to 9,000 cps, as measured at 25° C. using a Brookfield viscometer. In this case, the finally manufactured coating layer may have the form described in the exemplary embodiment described above.

The solid content of the coating layer forming composition may be 50 wt % to 65 wt %, specifically 55 wt % to 60 wt %. When the range is satisfied, even in the case in which the hole is filled with the coating layer forming composition as few times as once to three times, the hole may be filled with the coating layer forming composition in a high solid content, and finally the nail art having a large thickness may be manufactured.

Referring to (b) of FIG. 7, the mask is removed in S1-2, and accordingly, the side surface of the coating layer forming composition is deformed by gravity and the viscous property of the coating layer forming composition, and finally the coating layer may have the form described in the exemplary embodiment described above.

Referring to (c) of FIG. 7, S1-3 in which the coating layer forming composition is dried to form the coating layer 110 may include a drying process once or more. The drying process may include drying the coating layer in a temperature range of 60° C. to 120° C. for 30 minutes to 2 hours. The coating layer forming composition 110′ may become the coating layer 110 by the drying.

Referring to (d) of FIG. 7, the method for preparing a nail art may further include cutting the pre-substrate layer (120′ of (a)-(c) of FIG. 7) to form the substrate layer 120 (S2). Accordingly, one or more nail arts including the coating layer 110, respectively may be formed. In addition, the side surface and the lower surface of the substrate layer 120 may have an angle close to a right angle.

Hereinafter, preferred examples will be provided in order to assist in the understanding of the present disclosure, but it will be obvious that the following examples are only illustrative of the present disclosure, and various modifications and alterations may be made within the scope and technical idea of the present disclosure, and also it will be natural that these modifications and alterations may fall within the scope of the appended claims, to those skilled in the art.

### EXAMPLES AND COMPARATIVE EXAMPLES

### Example 1: Manufacture of Nail Art

(1) Preparation of Coating Layer Forming Composition

A urethane acryl-based oligomer (PU210) as a UV-curable raw material, trimethylbenzoyl phosphine oxide (TPO) as a photoinitiator, and an acryl resin having a glass transition temperature of 50° C. and a nitrocellulose resin ½ seconds as a resin were mixed with a dibasic ester as a solvent and stirring was performed to form a coating layer forming composition. A solid content of the coating layer forming composition was 55 wt %, and a weight ratio of the UV-curable raw material, the photoinitiator, and the resin in the solid content was 36:2:62. A viscosity of the coating layer forming composition was 6,500 cps at 25° C.

(2) Formation of Coating Layer

A mask including a hole having a nail art form was disposed on a pre-substrate layer including a design layer and an adhesive layer. The coating layer forming composition was disposed in the mask, while a predetermined pressure was applied by a squeeze member. The disposition process was repeated four times to adjust the thickness of the coating layer forming composition in the mask to 450 μm. Thereafter, the mask was removed, and then dried at 90° C. for 60 minutes to form a coating layer.

(3) Manufacture of Nail Art

Thereafter, the pre-substrate layer was cut to manufacture a nail art.

### Comparative Example 1: Manufacture of Nail Art

(1) Preparation of Coating Layer Forming Composition

A polyester acrylate-based oligomer (6311-100) as a UV-curable raw material, a product (184) available from Ciba as a photoinitiator, and a polyester resin and a nitrocellulose resin ½ seconds as a resin were mixed with ethylene glycol diacetate as a solvent and stirring was performed to form a coating layer forming composition. A solid content of the coating layer forming composition was 50 wt %, and a weight ratio of the UV-curable raw material, the photoinitiator, and the resin in the solid content was 20:2:78. A viscosity of the coating layer forming composition was 10,000 cps at 25° C.

(2) Formation of Coating Layer and Manufacture of Nail Art

Thereafter, the coating layer was formed and the nail art was manufactured in the same manner as in Example 1.

### Comparative Example 2: Manufacture of Nail Art

The nail art was manufactured in the same manner as in Example 1, except that when the coating layer was formed, the thickness of the coating layer forming composition in the mask was 60 μm.

### Comparative Example 3: Manufacture of Nail Art

When the coating layer was formed, the thickness of the coating layer forming composition in the mask was 800 μm. However, in this case, the coating layer forming composition was excessively spread, so that it was impossible to manufacture a desired nail art.

### Experimental Example 1: Thickness Observation

Each of the nail arts of Example 1 and Comparative Examples 1 and 2 was observed using equipment of VHX-970F available from Keyence, and then the results are shown in Table 1.

TABLE 1

| | T₁ | T₂ | T₃ | T₂ − T₁ | T₃ − T₂ |
|---|---|---|---|---|---|
| | (mm) | (mm) | (mm) | (mm) | (mm) |
| Example 1 | 0.12 | 0.42 | 0.7 | 0.3 | 0.28 |
| Comparative | 0.08 | 0.1 | 0.1 | 0.02 | 0 |
| Example 1 | | | | | |
| Comparative | 0.15 | 0.1 | 0.1 | −0.05 | 0 |
| Example 2 | | | | | |
| Comparative | Not | Not | Not | Not | Not |
| Example 3 | formed | formed | formed | formed | formed |

T₁ is a thickness of the nail art measured in an outer periphery of the nail art, and T₂ is a thickness of the nail art at a point of 1 mm away from the outer periphery of the nail art toward a center of the nail art. T₃ may be a thickness of the thickest portion of the nail art.

### Experimental Example 2: Evaluation of Wear Degree

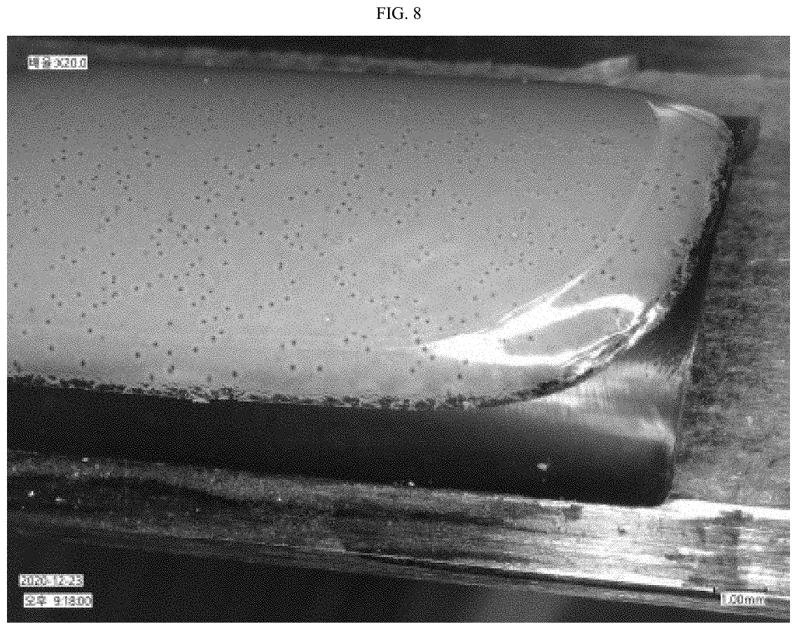

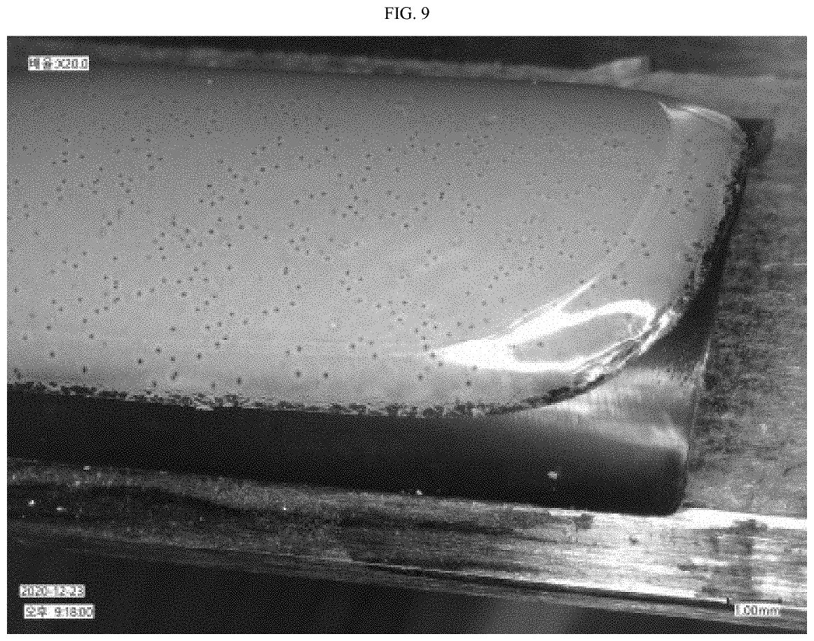

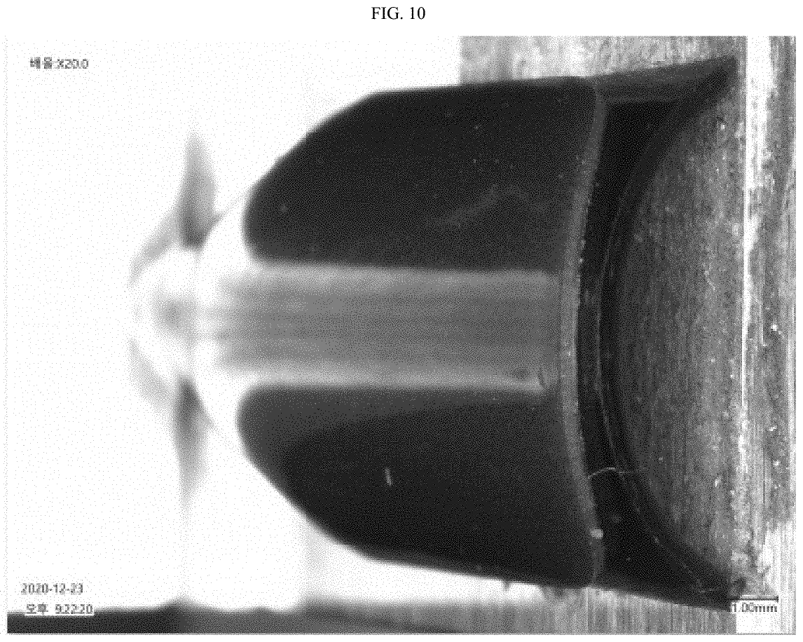

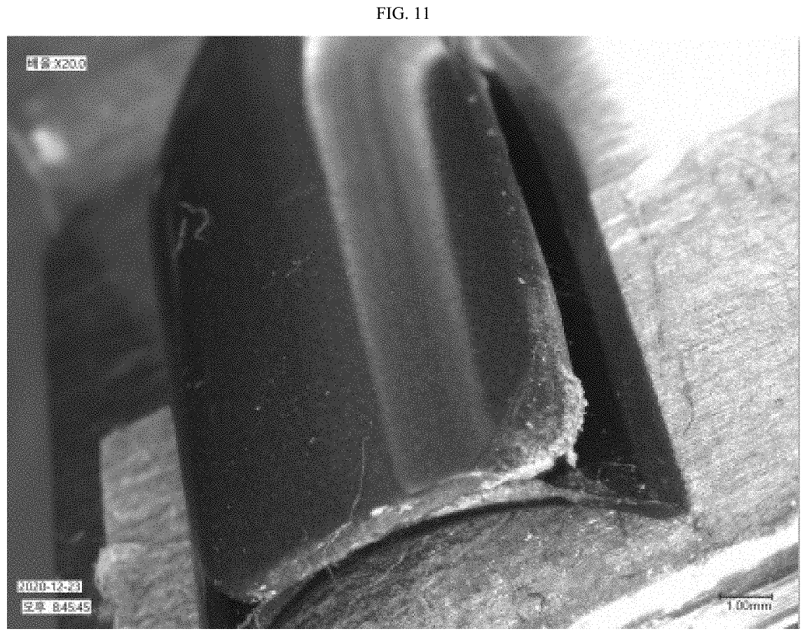

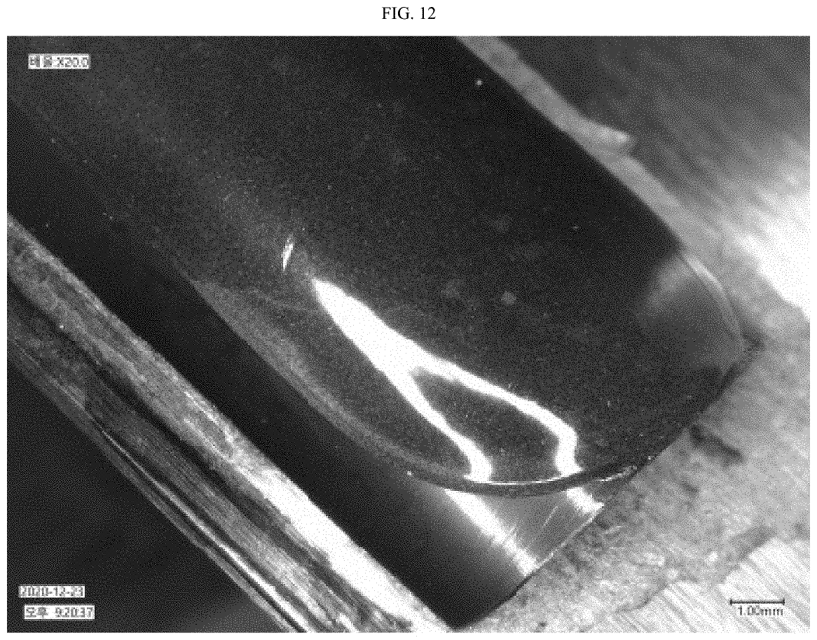

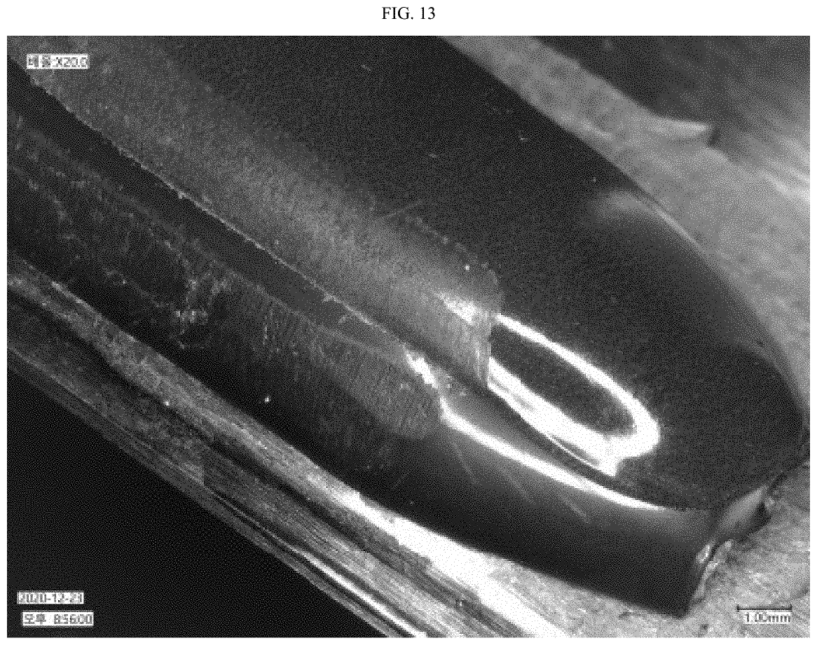

The thus-manufactured nail art was deformed to fit a nail model, and irradiated with UV to be cured. Thereafter, a side surface of the nail art was rubbed for a certain period of time and a wear degree was confirmed by a photograph. A photograph before the experiment of Example 1 is FIG. 8 and a photograph after the experiment is FIG. 9, a photograph before the experiment of Comparative Example 1 is FIG. 10 and a photograph after the experiment is FIG. 11, and a photograph before the experiment of Comparative Example 2 is FIG. 12 and a photograph after the experiment is FIG. 13. It was found that in Example 1, almost no wear occurred, but in Comparative Examples 1 and 2, the side surface was severely worn out.

According to the present disclosure, a thickness of the nail art is increased in a direction from the vicinity of the outer periphery of the nail art toward the center of the nail art, and thus, it may be suppressed that the vicinity of the outer periphery of the nail art has an excessively angular shape. Accordingly, wear of the nail art is suppressed, attachment ability is high, and the nail art may look three-dimensional to maximize beauty characteristics. In addition, according to the present disclosure, the nail art in the form described above may be manufactured by a relatively simple method, and thus, a simplified process and cost reduction are possible.

### DESCRIPTION OF SYMBOLS

100: nail art
100a: upper surface of nail art
100b: side surface of nail art
110: coating layer
120: substrate layer
121: adhesive layer
122: design layer
300: mask
300a: hole
110′: coating layer forming composition
120′: pre-substrate layer

What is claimed is:

1. A nail art comprising: a substrate layer and a coating layer positioned on the substrate layer,
wherein the coating layer includes a UV-curable raw material, a photoinitiator, and a resin, and
the following Equation 1 is satisfied:
0.05 mm≤T₂−T₁≤0.6 mm [Equation 1]
wherein T₁ is a thickness of the nail art measured in an outer periphery of the nail art, and
T₂ is a thickness of the nail art at a point of 1 mm away from the outer periphery of the nail art toward a center of the nail art.

2. The nail art of claim 1, wherein the thickness of the nail art is increased from the outer periphery of the nail art to a point of 1 mm away from the outer periphery of the nail art toward the center of the nail art.

3. The nail art of claim 1, wherein T₂ is 0.25 mm to 0.62 mm.

4. The nail art of claim 1, wherein T₁ is 0.015 mm to 0.35 mm.

5. The nail art of claim 1, wherein a thickness (T₃) of a thickest portion of the nail art is 0.5 mm to 0.8 mm.

6. The nail art of claim 5, wherein the following Equation 2 is satisfied:
0.05 mm≤T₃−T₂≤0.6 mm. [Equation 2]

7. The nail art of claim 1, wherein the UV-curable raw material is included at 10 wt % to 60 wt % in the coating layer.

8. The nail art of claim 1, wherein the UV-curable raw material includes at least any one selected from the group consisting of urethane acrylate-based oligomers, polyester acrylate-based oligomers, polyether acrylate-based oligomers, epoxy acrylate-based oligomers, polycarbonate acrylate-based oligomers, silicone acrylate-based oligomers, and acryl acrylate-based oligomers.

9. The nail art of claim 1, wherein the UV-curable raw material includes a urethane acrylate-based oligomer.

10. The nail art of claim 9, wherein the urethane acrylate-based oligomer includes at least any one of difunctional urethane acrylate-based oligomers, tetrafunctional urethane acrylate-based oligomers, hexafunctional urethane acrylate-based oligomers, and nonafunctional urethane acrylate-based oligomers.

11. The nail art of claim 1, wherein the photoinitiator has an absorption wavelength band in a range of 200 nm to 600 nm.

12. The nail art of claim 1, wherein the resin is included at 30 wt % to 80 wt % in the coating layer.

13. The nail art of claim 1, wherein the resin is a thermoplastic resin having a glass transition temperature (T_{g}) of 30° C. to 200° C.

14. The nail art of claim 1, wherein the resin includes at least any one selected from the group consisting of acryl-based resins, nitrocellulose resins, epoxy-based resins, polyester resin, polyvinyl resins, urethane resin, and vinyl acetate resins.

15. The nail art of claim 1, wherein an angle between a side surface of the substrate layer and a lower surface of the substrate layer is 85° to 110°.

16. The nail art of claim 1, wherein the substrate layer includes an adhesive layer.

17. The nail art of claim 16, wherein the substrate layer further includes a design layer disposed between the adhesive layer and the coating layer.

18. The nail art of claim 1, wherein a lower surface of the nail art is a flat surface.

19. A method for preparing a nail art, the method comprising: forming a coating layer from a coating layer forming composition by a screen printing method (S1),
wherein the nail art includes a substrate layer and the coating layer positioned on the substrate layer,
the coating layer includes a UV-curable raw material, a photoinitiator, and a resin, and
the following Equation 1 is satisfied:
0.05 mm≤T₂−T₁≤0.6 mm [Equation 1]
wherein T₁ is a thickness of the nail art measured in an outer periphery of the nail art, and
T₂ is a thickness of the nail art at a point of 1 mm away from the outer periphery of the nail art toward a center of the nail art.

20. The method for preparing a nail art of claim 19, wherein the thickness of the nail art nail art is increased from the outer periphery of the nail art to the point of 1 mm away from the outer periphery of the nail art toward the center of the nail art.

21. The method for preparing a nail art of claim 19, wherein S1 includes:
positioning a mask including a hole on a pre-substrate layer and then disposing the coating layer forming composition on the pre-substrate layer exposed by the hole (S1-1);
removing the mask (S1-2); and
drying the coating layer forming composition to form the coating layer (S1-3).

22. The method for preparing a nail art of claim 21, wherein in S1-1, the coating layer forming composition is disposed to have a thickness of 70 μm to 700 μm.

23. The method for preparing a nail art of claim 21, wherein S1-1 includes a squeeze process including disposing the coating layer forming composition inside the hole, and applying a pressure by a squeeze member.

24. The method for preparing a nail art of claim 23, wherein the squeeze process is performed once to five times.

25. The method for preparing a nail art of claim 19, wherein 29 wt % to 49 wt % of the UV-curable raw material, 1 wt % to 5 wt % of the photoinitiator, and 50 wt % to 70 wt % of the resin are included, in a solid content of the coating layer forming composition.

26. The method for preparing a nail art of claim 19, wherein the coating layer forming composition has a viscosity of 4,500 cps to 10,000 cps, as measured at 25° C. using a Brookfield viscometer.

27. The method for preparing a nail art of claim 19, wherein the solid content of the coating layer forming composition is 50 wt % to 65 wt %.

28. The method for preparing a nail art of claim 21,
wherein S1-3 of drying the coating layer forming composition to form the coating layer includes a drying process once or more, and
the drying process is performed at 60° C. to 120° C.

29. The method for preparing a nail art of claim 21, further comprising: cutting the pre-substrate layer to form the substrate layer (S2).
